(19) United States
(12) Patent Application Publication
(10) Pub. No.: US 2026/0097902 A1
(43) Pub. Date: Apr. 9, 2026

(54) SELF-STACKING SPIRAL BELT WITH A LEADING BEND AND RIBBED DRIVE CHAINS

(71) Applicant: Ashworth Bros., Inc., Fall River, MA (US)

(72) Inventors: Ricardo Pio Barakat Biscioni, Sao Paulo (BR); Darroll Joseph Neely, Winchester, VA (US)

(21) Appl. No.: 19/343,711

(22) Filed: Sep. 29, 2025

Related U.S. Application Data
(60) Provisional application No. 63/700,745, filed on Sep. 29, 2024.

(51) Int. Cl. B65G 17/38; B65G 21/18

(52) U.S. Cl. CPC B65G 17/385; B65G 21/18; B65G 2207/24

(57) ABSTRACT

A lateral plate element for a link of a self-stacking endless conveyor belt including an outer plate section, an inner plate section and a connection bend section connecting said outer and inner plate sections; a resting surface arranged to engage a lateral plate element of an underlying tier of the self-stacking endless conveyor belt when it extends helically; an inner abutment, arranged to engage an upper portion of the underlying lateral plate element, wherein the inner abutment surface limits outward lateral movement of the lateral plate element relative to the underlying lateral plate element; and an outer abutment surface arranged to engage the upper portion of the underlying lateral plate element, wherein the outer abutment surface limits inward lateral movement of the lateral plate element relative the underlying lateral plate element.

### CROSS-REFERENCE TO RELATED APPLICATIONS

This application claims priority to U.S. Provisional Application No. 63/700,745, filed Sep. 29, 2024, and entitled “Self-Stacking Spiral Belt with a Leading Bend and Ribbed Drive Chains,” the entire disclosure of which is incorporated herein by reference.

### BACKGROUND

### Technical Field

The disclosures herein relate to stacker spiral belt systems. Specifically, the disclosed invention relates to a stacker belt with a leading bend, the leading bend on the plate creates a more hygienic design since it avoids the creation of belt pockets on the edges of the belt, belt pockets are common on prior-art stacker belts which have an underside bend which creates the outer abutment of the plate, a leading bend configuration allows for a better welding of the stacker plate to the belt rod ends. In some embodiments, a weldless design for better servicing the belt and an improved interlock between tiers is achieved. The disclosure also relates to a drive chain wherein the contact between the first belt tier and the drive chain is improved by means of a ribbed design that directly connects to the self-stacking plates to restrict inwards and outwards belt movement thus avoiding de-stacking of the first tier of the belt pile.

### State of the Art

Spiral conveyor belt systems enjoy widespread use in the manufacturing and commercial food processing industries. A spiral system is, essentially, a conveyor belt that moves in a corkscrew-shaped path to vertically transit items upwards or downwards on the belt along a lengthened helical path. This is useful to move parts through a process across different vertical levels using a small footprint. Spiral belts create a long path within a small space and are commonly used to move food products through a cooler, oven, or freezer, to cool, or to cook food products during a lengthier time frame. The helical configuration used by a spiral system can accommodate hundreds of meters of belt path within a relatively small floor area.

Lateral displacement of the belt turns once belt is stacked on the pile is an undesirable effect which can cause product loss and damage to system components. The embodiments disclosed herein provide efficient means to prevent lateral displacement of the belt turns since the plate bend is located at the leading portion instead of at the underside of the plate. A flange configuration with a straight down portion is also applied so the belt is secured in a better interlocking position during piling of the belt turns. In contrast, at least one prior art design has an inwardly bent flange without a straight down portion which can easily be displaced laterally.

Lateral displacement may also happen between the first belt tier and the drive chain, that is, not between tiers but at the very first tier. The ribbed drive chain embodiment allows the bottom of the self-stacking plate first tier to directly engage both the inner and outer drive chain, whereas prior art outer chain configurations merely support the self-stacking underside bend of the plate. The embodiments disclosed herein improve the connection so that the belt cannot move inwards or outwards on the outer drive chain.

Belt food entrapment is a major issue in the food industry due to contamination. For example, belt pockets are areas difficult to clean and that can accumulate a lot of residues. The configurations presented herein eliminate the pockets at both edges of the belt.

Stacker system belts may fail at the welding locations due to the high weight of belt tiers above and product being conveyed that must be supported by the lower belt tiers. The disclosed plate embodiments improve welding of the rods to the stacker plates since they create a bigger area of contact between the components.

Servicing stacker belts may be challenging due to the required welding of the rods to the self-stacking plates. Prior art side plates require welding to hold the rods in position so they do not move sideways. By changing the direction of the bend, a weldless connection can be established for better servicing the belt. Common practice is opening the belt for reducing length after elongation. A weldless connection presents servicing advantages over prior art designs.

Crooked belt side plates may cause problems with tiers interlocking and further belt damage, and thus, a stronger design is desirable. The change on the plate bend direction, as presented herein, provides additional strength to the stacker belt.

For at least the foregoing reasons, there is a need for a spiral conveyor stacker belt that overcomes the deficiencies discussed herein above.

### BRIEF SUMMARY

Disclosed herein are embodiments of a spiral conveyor belt. Embodiments of the system allow for an improved belt compared to prior art. By changing the direction of the plate bend several benefits are achieved including stronger weldments of the belt components and increased bearing load because the plate moment-of-inertia is higher on this condition, a more hygienic design with no pockets for food entrapment, and a better interlocking between tiers.

In some embodiments, the bottom flange of the belt may have a straight down portion which helps to improve the interlocking between tiers.

In some embodiments, the belt may have a tension link to increase the allowable tension of the belt.

In some embodiments, the belt may have a wire mesh for product support.

In some embodiments, the belt may be weldless or partially welded, that is a welded trailing rod and a weldless leading rod.

Some notable embodiments include:

A lateral plate element for a link included in a self-stacking endless conveyor belt comprising a plurality of interconnected links, rods and mesh overlay in which the conveyor belt extends helically along part of its length such that upper edge portions of the lateral plate elements of the links in an underlying tier bear against lower edge portions of the lateral plate elements of the links in an overlying belt tier, the lateral plate element of the link comprising: an outer plate section, an inner plate section and a connection bend section connecting said outer and inner plate sections; a resting surface arranged to engage a lateral plate element of an underlying tier of the self-stacking endless conveyor belt when it extends helically; an upper portion with an associated upper edge arranged to engage a resting surface of a lateral plate element of an overlaying tier of the self-stacking endless conveyor belt when it extends helically; an inner abutment, arranged to engage the upper portion of the underlying lateral plate element, wherein the inner abutment surface limits outward lateral movement of the lateral plate element relative the underlying lateral plate element; an outer abutment surface arranged to engage the upper portion of the underlying lateral plate element, wherein the outer abutment surface limits inward lateral movement of the lateral plate element relative the underlying lateral plate element.

A set of drive chains to drive the inner and outer edges of the self-stacking belt pile.

An outer drive chain with a rib on the top to engage the bottom tab of the plate elements described.

A set of inner and outer chains, wherein the inner chain has a Z tab and the outer chain has a rib.

A set of inner and outer chains, wherein the inner and outer chains have a rib.

A set of inner and outer chains, wherein the inner chain has a rib and the outer chain has a plain surface.

A drive chain, wherein the rib has a square cross section.

A drive chain, wherein the rib has a rectangular cross section.

A drive chain, wherein the rib has a triangular or circular cross section.

Lateral plate element, wherein the outer abutment surface is formed by a leading bend.

Lateral plate element, wherein the outer abutment surface is formed by both a leading bend and trailing bend.

Lateral plate element, wherein the plate element has 2 holes and 1 slot and the outer abutment has 2 holes.

Lateral plate element, wherein the plate element has 2 holes and 1 slot and the outer abutment has 1 hole.

Lateral plate element, wherein the plate element has 2 rod holes and 1 slot and the outer abutment has no holes.

Lateral plate element, wherein the plate element has additional holes for air flow.

Lateral plate element, wherein the outer abutment surface created by the leading bend covers the two transverse rods.

Lateral plate element, wherein the outer abutment surface created by the leading bend covers only the closest rod to the bend.

Lateral plate element, wherein the inner abutment surface is formed by a diagonally downward flange.

Lateral plate element, wherein the inner abutment surface is formed by a diagonally downward flange and a straight down flange.

Lateral plate element, wherein the outer abutment surface has a bottom tab for locking underlying plate in place.

Lateral plate element, wherein the transverse rod ends are chain welded to the outer surface of the plate element.

Lateral plate element, wherein the transverse rod ends are partially welded to the outer surface of the plate element.

Lateral plate element, wherein the connection between the rod ends and the outer surface of the plate element are not welded for better servicing.

Lateral plate element, wherein the connection of one transverse rod is welded and the connection of the second transverse rod is weldless.

Lateral plate element, wherein the connection of the weldless transverse rod to the outer abutment surface is made by a nut.

Lateral plate element, wherein the connection of the weldless transverse rod to the outer abutment surface is made by an elastic ring or pin.

Lateral plate element, wherein the leading bend has a cut for rod connection.

Lateral plate element, wherein the trailing bend has a cut for rod connection.

Lateral plate element, wherein both the trailing bend and leading bend have a cut for rod connection.

Lateral plate element, wherein the outer abutment face has a horizontal indentation.

Lateral plate element, wherein the outer abutment face has a vertical indentation.

Lateral plate element, wherein the outer abutment face has a protruding tab for side drive.

In one aspect, the present disclosure is directed to a lateral plate element for a link of a self-stacking endless conveyor belt. The lateral plate element includes an outer plate section, an inner plate section and a connection bend section connecting said outer and inner plate sections; a resting surface arranged to engage a lateral plate element of an underlying tier of the self-stacking endless conveyor belt when it extends helically; an inner abutment, arranged to engage an upper portion of the underlying lateral plate element, wherein the inner abutment surface limits outward lateral movement of the lateral plate element relative to the underlying lateral plate element; and an outer abutment surface arranged to engage the upper portion of the underlying lateral plate element, wherein the outer abutment surface limits inward lateral movement of the lateral plate element relative the underlying lateral plate element.

In another aspect, the present disclosure is directed to a drive chain for a conveyor belt. The drive chain may include a plurality of links, each link including an upper plate, and the upper plate including an upwardly projecting rib extending along a length of the link.

In another aspect, the present disclosure is directed to a drive chain for a conveyor belt. The drive chain may include a plurality of links, each link including an upper plate; the upper plate including an upwardly projecting rib extending along a length of the link.

In another aspect, the present disclosure is directed to a spiral conveyor belt system. The system may include a plurality of interconnected links and rods in which the conveyor belt extends helically along part of its length such that upper edge portions of the lateral plate elements of the links in an underlying belt tier bear against lower edge portions of the lateral plate elements of the links in an overlying belt tier, the lateral plate element of the link comprising: an outer abutment arranged to engage the upper portion of the underlying lateral plate element, wherein the outer abutment surface limits inward lateral movement of the lateral plate element relative the underlying lateral plate element; and a drive chain including a plurality of chain links, each chain link including an upper plate; the upper plate including an upwardly projecting rib extending along a length of the link; wherein the outer abutment includes a notch on an underside of the outer abutment, wherein the notch is configured to receive the upwardly projecting rib of the drive chain.

In another aspect, the present disclosure is directed to a lateral plate element for a link of a self-stacking endless conveyor belt. The link includes an outer plate section, an inner plate section, and a connection bend section connecting said outer and inner plate sections. The outer plate section includes a resting surface arranged to engage a lateral plate element of an underlying tier of the self-stacking endless conveyor belt when it extends helically. In addition, the link includes an outer abutment including an underside bend and a downwardly extending tab configured to limit inward lateral movement of the lateral plate element relative an underlying lateral plate element.

The features and advantages of the invention will be apparent to those of ordinary skill in the art from the following more particular description of several example embodiments of the disclosed system and methods, and the accompanying drawings.

### BRIEF DESCRIPTION OF THE DRAWINGS

FIG. 1 is a perspective view of an example prior art stacker spiral conveyor system;

FIG. 2 is a perspective view of an example prior art stacker belt with an underside bend;

FIG. 3A is a front view of the prior art belt interlocked;

FIG. 3B is another front view of the prior art belt but not interlocked;

FIG. 4A is a top view of a heavy-duty prior art belt with underside bend;

FIG. 4B is a front view of the belt shown in FIG. 4A;

FIG. 5 is a view of prior art belt with underside and lateral bends;

FIG. 6 is a view of prior art belt with a feature at the underside bend to better interlock tiers;

FIG. 7 is a prior art drive chain in contact with the self-stacking belt;

FIG. 8A is a perspective view of a self-stacking link embodiment with a leading bend and having two holes on the outer abutment surface;

FIG. 8B is perspective view of another self-stacking link embodiment with a leading bend and having no holes on the outer abutment surface;

FIG. 9 is a perspective view of a self-stacking link embodiment with only one hole on the outer abutment surface;

FIG. 10A is a top view of a self-stacking link embodiment with a leading bend;

FIG. 10B is a perspective view of the link shown in FIG. 10A;

FIG. 10C is a side view of the link shown in FIG. 10A;

FIG. 10B is a front view of the link shown in FIG. 10A;

FIG. 11A is a perspective view of a self-stacking link embodiment with a half leading bend;

FIG. 11B is a top view of the link shown in FIG. 11A;

FIG. 12 is a perspective view of several self-stacking link plates with belt rods chain welded;

FIG. 13 is a perspective view of two half bend link plates connected;

FIG. 14 is a front view of two belt tiers interlocked;

FIG. 15 is a front view of the plate showing an embodiment with straight down flange portion and diagonally downwards and inwards flange;

FIG. 16 is a perspective view of the plate embodiment showing the straight down flange portion;

FIG. 17 is a front view of the plates embodiment with straight down flanges interlocked;

FIG. 18 is a perspective view of a reduced radius belt with a sharp leading bend and a trailing bend cut;

FIG. 19 is a perspective view of an embodiment of the plate link with no welds at the leading rod;

FIG. 20 is a view of a weldless connection with an outer and inner fastener at the outer abutment;

FIG. 21 is a perspective view of the tension links;

FIG. 22 is a perspective view of the spiral outfeed sprocket engaged on the self-stacking belt side plate;

FIG. 23 is a perspective view of an embodiment of the ribbed drive chain engaged to the self-stacking side plate;

FIG. 24 is a perspective view of the inside of a ribbed drive chain engaged to the self-stacking plate;

FIG. 25 is a perspective view of the two main plates that compose the ribbed drive chain;

FIG. 26 is a side view of the ribbed drive chain embodiment engaged to the self-stacking plate;

FIG. 27 is an exploded view of the main ribbed drive chain components;

FIG. 28 is a view of the ribbed drive chain on a slope engaging a belt section above;

FIG. 29 is a perspective view of prior art inner drive chain with a Z tab for belt location;

FIG. 30 is a schematic form of the inner and outer drive chains of a spiral self-stacking belt;

FIG. 31 is a perspective view of the inner and outer drive chain, drive motors and structural stands;

FIG. 32A is a perspective view of a horizontal indentation on the outer abutment face;

FIG. 32B is another perspective view of the horizontal indentation on the outer abutment face, shown from the opposite side as FIG. 32A;

FIG. 33A is a perspective view of a vertical indentation on the outer abutment face;

FIG. 33B is another perspective view of the vertical indentation, shown from the opposite side as FIG. 33A;

FIG. 34 is a view of two side links with vertical indentations interlocked;

FIG. 35 is a view of a side link with a protruding tab for side engagement;

FIG. 36 is a perspective view of a heavy-duty plate embodiment;

FIG. 37 is a perspective view of an embodiment with an undercut 140 as a resting surface;

FIG. 38 is a schematic end view of an embodiment of a lateral plate element with an underside bend; and

FIG. 39 is a schematic front view of the embodiment shown in FIG. 38.

### DETAILED DESCIPTION

Various example embodiments of a stacker spiral conveyor belt are discussed herein. The belt includes rods, inner and outer side plates, tension links, wire meshes and weldment. Embodiments of the disclosed stacker belt have advantages over existing stacker belts, including, for example, a more hygienic design without belt pockets at the belt edges.

Details of a stacker spiral conveyor system are first discussed generally, followed by descriptions with reference to the several drawing figures. It is conceived that the concept of providing a spiral conveyor belt for which a stronger bearing load, a more hygienic design, better welding, and better interlocking between tiers are benefits associated therewith is within the scope of these disclosures. The utility of such a system as disclosed herein, not merely with the disclosed embodiments but across a range of side plate designs will be immediately appreciated by those having ordinary skill in the art.

### Definitions

As used herein, “tier” means a complete turn of the belt around the drum, in other words the distance between belt levels around the spiral path.

As used herein, “belt” means an elongated, continuous, flexible structure formed from a plurality of links coupled together with a plurality of bars oriented orthogonal to the links. In some embodiments, the belt includes a mesh or wire grid providing a surface upon which product transported by the spiral conveyor system is supported. “Belt” encompasses all structures and substructures moving along a helical path. “Belt” is used loosely in certain disclosures herein to refer to a limited length of an entire belt structure.

As used herein, “link” means a structure disposed along one of the edges (inner edge or outer edge) of a belt. The link is part of the belt. Each single link is coupled to two adjacent links-one forward link and one trailing link with respect to the direction of belt travel-by two or three support rods, in some embodiments.

As used herein, “system turn ratio” means the ratio between the radius traveled by the inner belt edge along a helical path; i.e., the distance from the inner belt edge to the central axis of the helical path, and the belt width.

As used herein, “inner edge and outer edge” are related to the belt moving in a path tracing a helix having an inner radius and an outer radius. The outer-edge of the belt moves in a similar helical path having an outer radius. Otherwise stated, the inner radius is the linear distance from a central axis of rotation to the inner belt edge. The outer radius is the corresponding linear distance from the central axis of rotation to the outer belt edge. The outer radius of the belt helical path (belt outer edge) is inherently larger than the inner radius of a belt helical path.

As used herein plate, side plate, lateral plate, side link, self-stacking plate and link are used interchangeably.

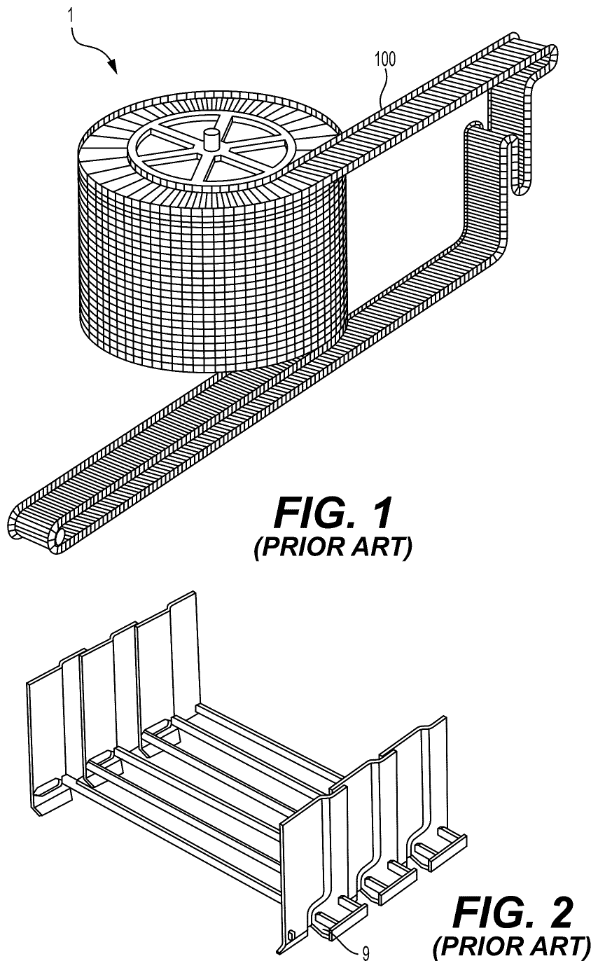

FIG. 1 is a perspective view of an example prior art stacker spiral conveyor system; it shows prior art system 1 comprising belt 100 extending along a helical path. Belt begins at infeed and terminates at outfeed. The prior art system shown in FIG. 1 depicts aspects common to all stacker spiral conveyor systems. The belt translates vertically along a helical path, moved by a pair of inner and outer bottom drive chains (not shown) which support the pile of belt. Belt may be moved in either direction, clockwise or counter-clockwise, depending on the direction of rotation of the drive chains.

FIG. 2 is a perspective view of an example of prior art stacker belt in which the underside bends 9 can be seen. This underside bend creates a horizontal surface on which residues can be deposited, making the cleaning of the belt inconvenient. In addition, there is not enough frontal surface for a complete fusion of the rod ends, thus delivering a poor welding connection.

FIG. 3A is a front view of prior art belt interlocked. As shown in FIG. 3A, an inward flange 6 has an angle compared to the plate. With this configuration, any lateral force applied to a top tier may displace the belt from the tiers below, causing de-stacking of the pile, de-stacking generates product loss, damage to the belt plates, damage to the system components, and spiral shut down. FIG. 3B shows the underside bend de-stacked from the plate below. Due to the angle at the underside bend, the upper tier of the belt can be easily moved inwards.

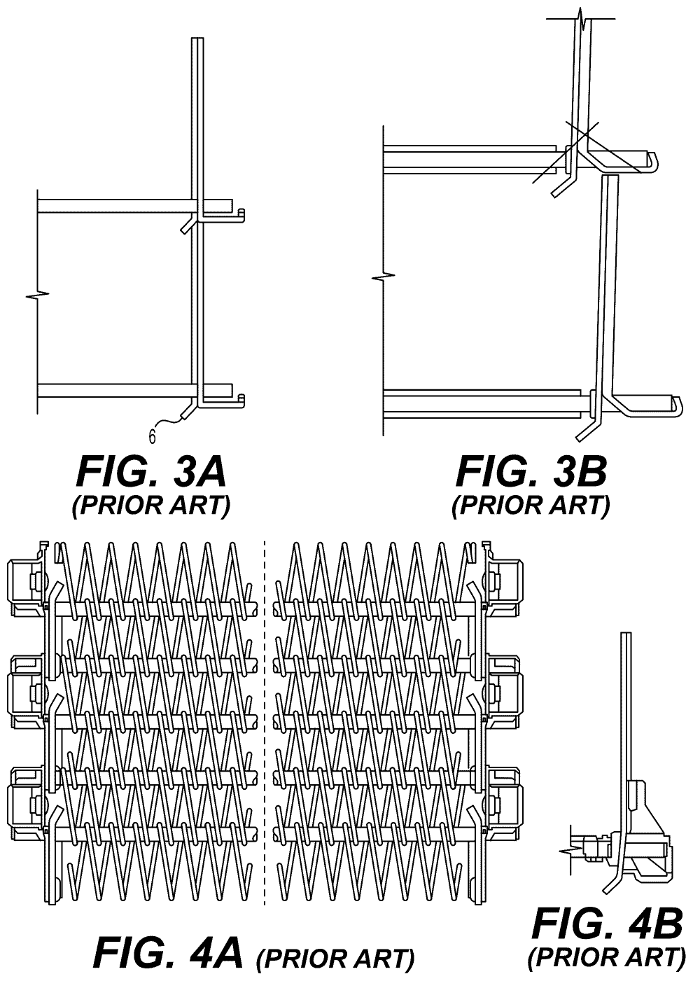

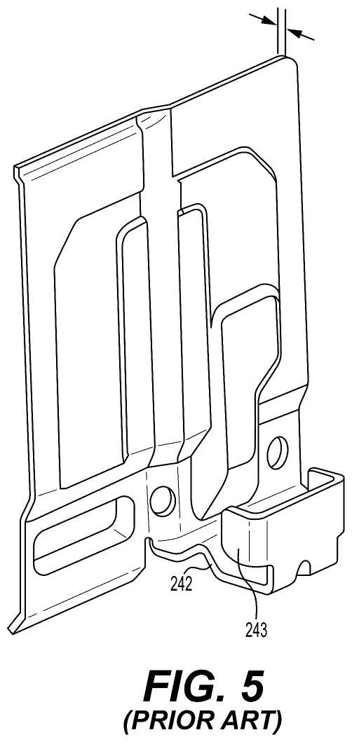

FIG. 4A is a top view of a prior art heavy-duty stacker belt which also presents an underside bend. As shown in FIG. 4B, the underside portion receives additional lateral bends. Due to the underside bend, this belt type also presents a horizontal surface for residues accumulation.

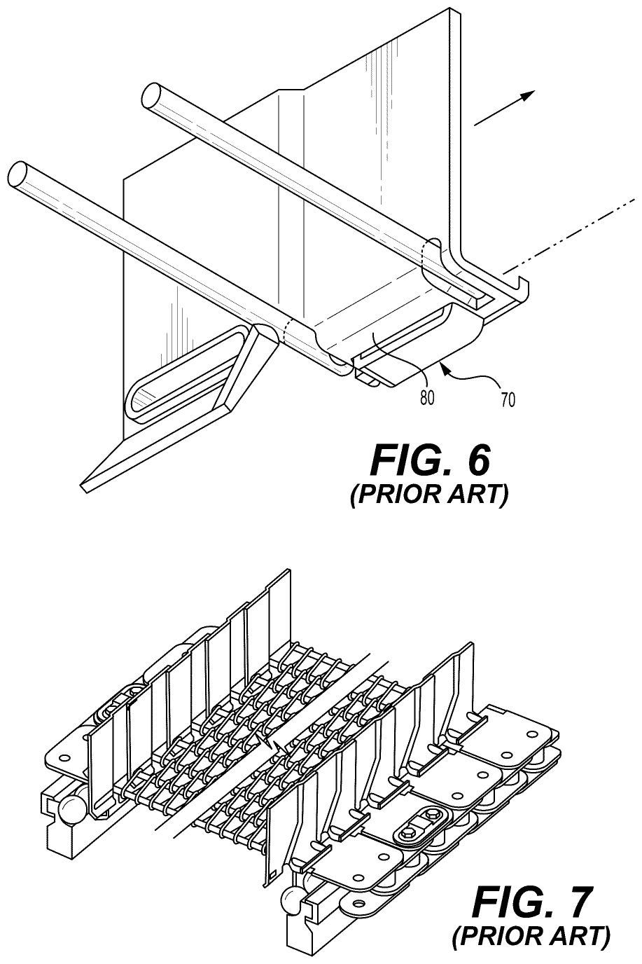

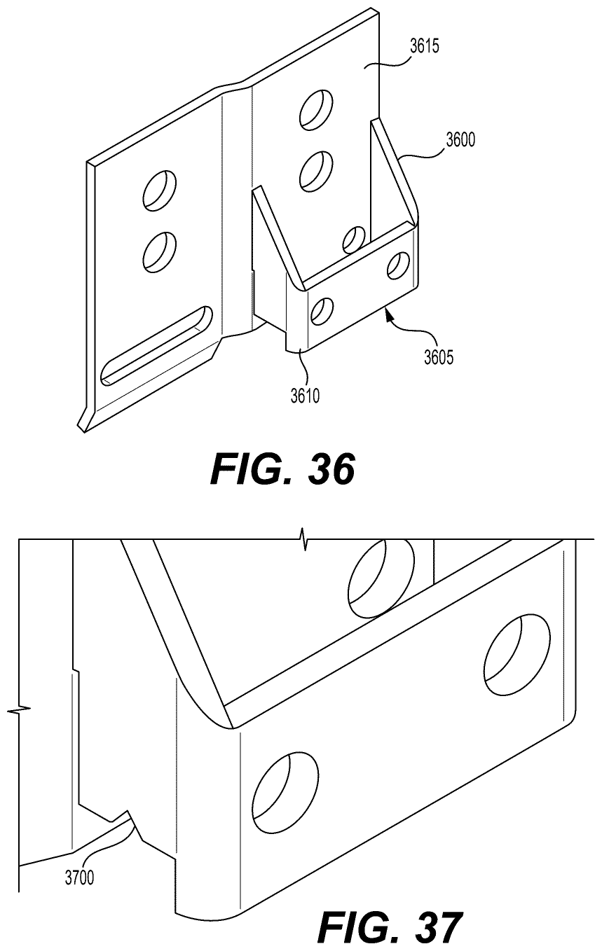

FIG. 5 is a view of a prior art belt link formed with an underside bend and lateral bends. A horizontal surface formed by the underside bend can be seen. In addition, this specific plate type has an underside bump 242 to better interlock the tiers. However, while this may help to reduce the likelihood of de-stacking between tiers, it is not effective since the bump has angled edges, so the inward force is decomposed generating an upper force which may lift the belt and finally de-stack it. In contrast, the embodiment shown in FIG. 36 is straight down so inwards forces are not decomposed and the likelihood of de-stacking is more effectively reduced.

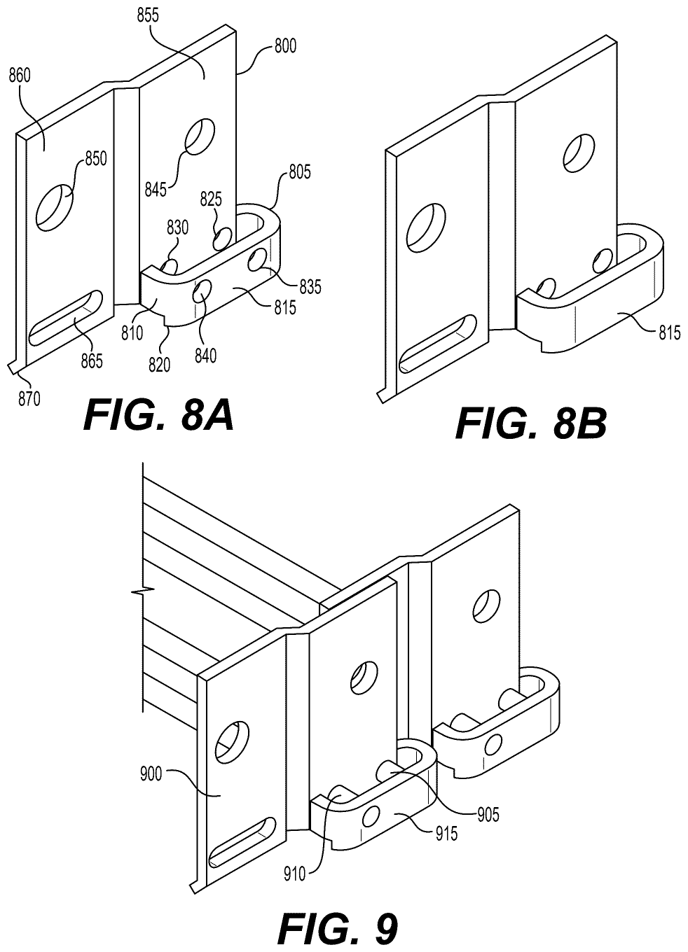

With further regard to FIG. 5, rod is welded to surface 243. However, with such a small surface area where the rod may contact surface 243, the strength of a possible welded connection of these components may be less than desirable. the embodiment with a leading bend 805 (see FIG. 8A) generates a bigger area of contact of the rod ends circumference to the outer abutment so a chain weld may be applied, additional material may be used or the fusion of the rod tip may be achieved without additional material with a TIG weld.

FIG. 6 is a view of a prior art belt where a bottom feature 70 is formed downwards at the underside bend 80 in order to improve interlocking between tiers of the belt pile.

FIG. 7 is a perspective view of prior art drive chain. The belt is only supported by the chain at the outside and held in position by means of Z tabs at the infeed chain surface, force applied inwards to the belt at the outer chain may displace the belt since there is no mechanical connection other than friction between the plate underside and surface of the outer drive chain.

FIG. 8A is a perspective view of the first embodiment of a lateral plate element 800 without an underside bend. The plate element comprises an outer abutment structure formed by a leading bend 805 at the leading edge of the stacker plate. The bend may be circular in some embodiments as shown, whereas in other embodiments the bend may be sharp, that is forming a sharp angle to the side plate. Leading bend 805 format may vary in size and format as desired. Trailing bend 810 may be welded to the side plate to close the link, whereas in some embodiments it may not be welded or may be omitted entirely.

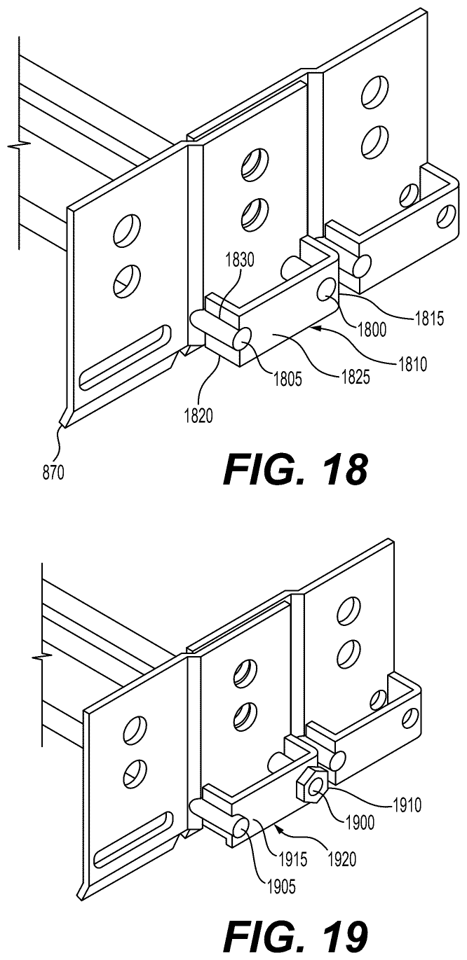

In some embodiments, the outer abutment 815 may terminate close to the transversal rod, but not completing the loop. Bottom tab 820 allows the underlying belt tier to rest and lock in position, thus providing a more effective interlocking than prior art. In addition, each link includes two transverse rods (see rods 1800 and 1805 in FIG. 18), with the belt rod ends passing thru the plate holes 825, 830 and front holes 835, 840 to be welded to the outer abutment surface 815.

In some embodiments, the outer abutment surface 815 may have no holes, as shown in FIG. 8B. In such embodiments, the transverse rods may contact the inside of the loop of the abutment surface to be welded. In some embodiments, no welding is required, and joining of the belt rod ends and outer abutment surface may be made with a nut (see FIG. 19), elastic ring, or pin for better servicing the belt during splicing. Normally when manufacturing the links, two opposite and mirrored link plates 800 are joined together by the rods to form a pitch of the belt. The belt is formed of a plurality of pitches.

The belt components (rods, plate links, mesh) are usually made of stainless steel but other materials may be suitable depending on the application requirements. The link plate thickness is usually from 1 to 3 mm thick. Referring again to FIG. 8A, self-stacking plates 800 may have holes 845, 850 at portions 855, 860 so that airflow is allowed at the inside in a freezer application for example. In some embodiments, outside plate links 800 may have no holes so air flow is contained. It will be understood that portions 855, 860 may each have one or more holes. Usually, the holes of portions 855, 860 of inner adjacent plates align when the belt is collapsed. Slot 865 allows the rod of an adjacent plate link to slide and collapse the belt 100 for curving applications. In some embodiments, both the inner and outer plates may have the slot, in some embodiments only the inner plate may have the slot while the outside plate has a circular hole depending on the system take-up configuration, which can be accumulative, horizontal, or vertical.

FIG. 9 is a perspective view of a link 900 having an outer abutment surface 915 with one hole only. In such embodiment, the first transverse rod 905 stops at the inner surface of the abutment, while the second transverse rod 910 goes all the way out to be welded to the outer surface. In some embodiments, the first transverse rod 905 may be used for servicing the belt. For example, in some cases, the first transverse rod 905 does not receive any welding so splicing of the belt is more convenient. In other embodiments, both the first and second may be welded to the outer abutment, whereas in still other embodiments, both the first and second rods are not welded to the outer abutment.

Both the inner and outer plates of the belt are mirrored but carrying the same features between them. For final positioning of the rod on the weldless embodiments, the rod end may be bent with a screwdriver for example to pass over or under the outer abutment of the link so the rod can correctly enter the opposite link being spliced, afterwards the bent rod end is hit back to fall in position and locked. The outer abutment of the plate may have any height, even equal to the plate height.

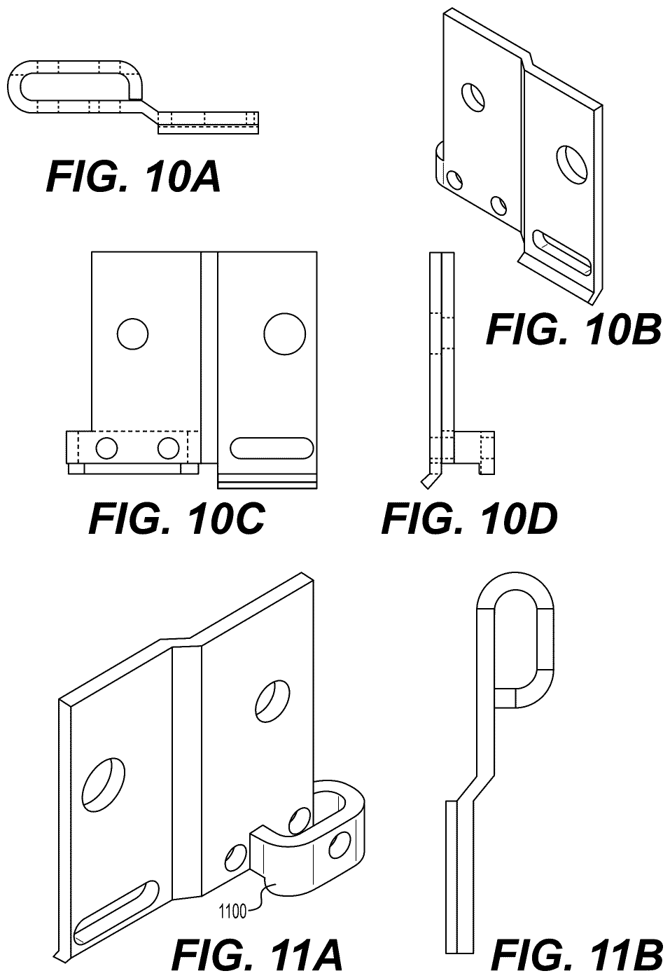

FIGS. 10A-10D are, respectively, top, perspective, side, and front views of the link with a leading bend. As shown in FIG. 10A, there is no horizontal surface for residue accumulation as with prior art belts having an underside bend, thus providing a more hygienic design for food applications.

FIGS. 11A and 11B are perspective and top views of a link with a half leading bend. With the half leading bend, a shorter loop is formed covering the first rod only. The loop may be closed and welded or open, without weld or without the trailing bend 1100.

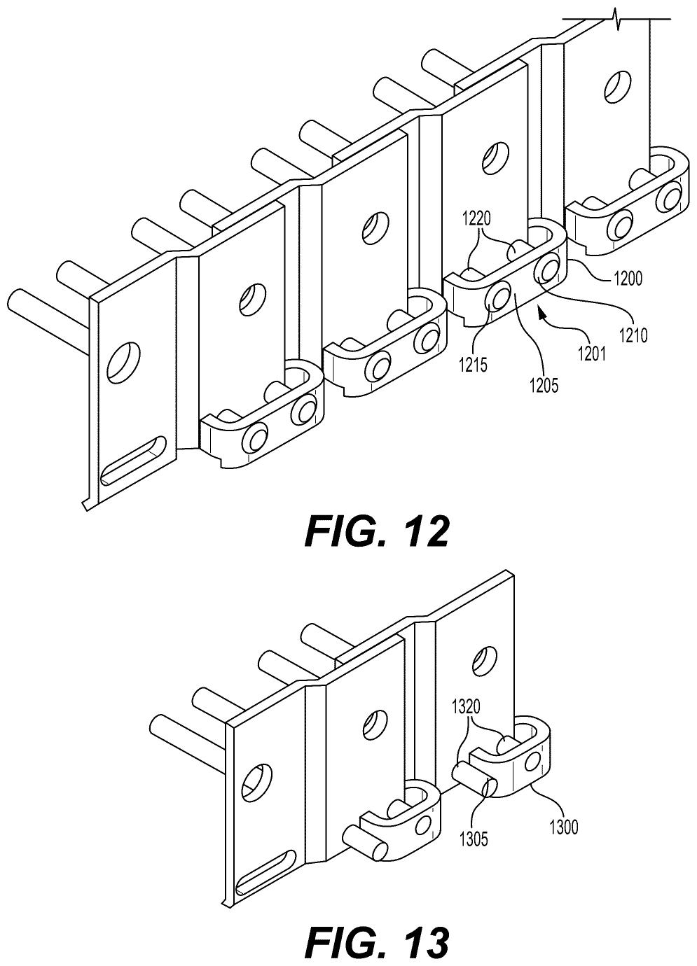

FIG. 12 is a perspective view of the belt with a full leading bend 1200 or loop. As shown in FIG. 12, weldment of rod ends to the front surface 1205 of the outer abutment 1201 are shown. For example, welds 1210, 1215 may be full or partial along the rod tip circumference. Alternatively or additionally, rods may be welded at locations 1220 as well at the outside or inside of the stacker plate. The connection between outer and inner plates, rods and a mesh for product support form a self-stacking belt.

Typically, the most common turn ratio of these systems is 1.7, where the inside radius of the turn is equal to 1.7 times the belt width. It will be understood that other turn ratios may be achieved depending on the size of the plate slot and leading bend. Small radius stacker belts are formed with an intermediate row of specially designed links between inner and outer links so the belt can turn smaller than 1.7 turn ratios. In some embodiments, the outer edge of the belt has a bigger pitch than the inside edge of the belt. Turn ratios of the belts may be controlled by the size of the plate slot, leading bend size, position, and distance of the rods on the outer abutment surface.

FIG. 13 is a perspective view of a leading bend belt with a half bend 1300, on this design welding 1305 may join the plate to the rod. Welding at locations 1320 and/or at the rod ends (see 1210 and 1215 in FIG. 12) may also be used for fixing the rods to the side plates.

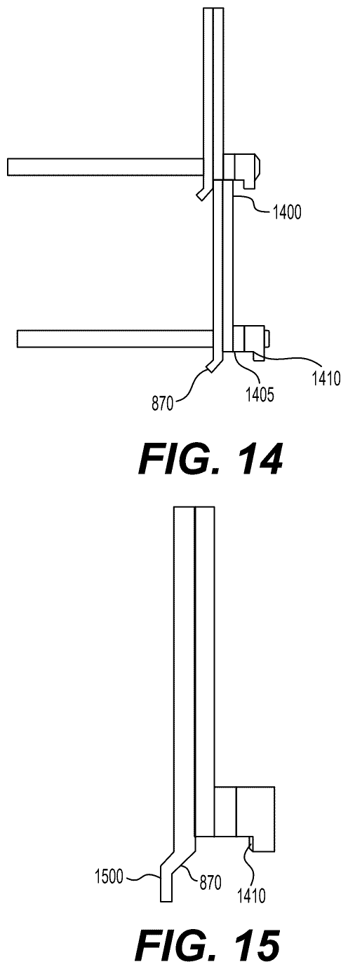

FIG. 14 is a front view of two belt tiers interlocked. As shown in FIG. 14, the link plates may include a diagonally downward and inward flange 870 can be provided at the bottom of the side plate. The link upper edge portions 1400 of the links in an underlying belt tier bear against lower edge portions 1405 of the links in an overlying belt tier. In addition, flange 870 and bottom tab 1410 of the plates hold the plates so they do not move inwards or outwards. The resting surface 1415 at lower edge portions is not planar as prior art belts since the bend is not on the underside of the plate link but in front of it. When the conveyor belt is stacked in tiers the upper portion of a lateral plate element of an underlying tier rest against the portion 1415 and not on the transverse rods. Accordingly, the belt rods do not wear against the upper portion of the side plates.

FIG. 15 is a front view of another embodiment of the lateral plate element. As shown in FIG. 15, in some embodiments, the link plate may include a straight down flange 1500 following the diagonally downward and inward flange 870. Straight down flange 1500 makes de-stacking more difficult to take place since it limits outward lateral movement when a force is applied on the piled belt, third embodiment bottom tab 1410 also makes de-stacking unlikely when inward forces are applied to the belt pile. Both features combined create a better interlocking of tiers when compared to prior art belts. In some embodiments, the distance between the bottom flange 870 and bottom tab 1410 may be two to six times the thickness of the side plate.

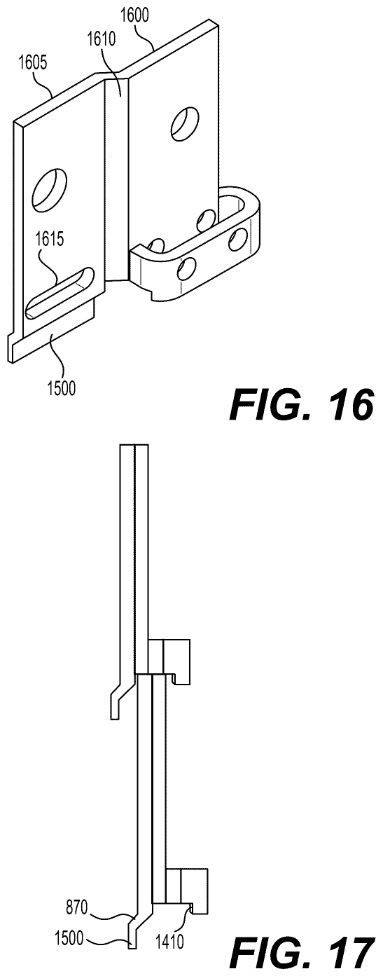

FIG. 16 is a perspective view of the plate link shown in FIG. 15 with a straight down flange 1500, the lateral plate includes an outer plate section 1600, an inner plate section 1605 and a connection bend section 1610 which connects the inner and outer plate sections. As shown in FIG. 16, the inner plate section 1605 is offset in an inward direction with respect to the outer plate section 1600. It will be understood that the value of the offset may vary. In some embodiments, the value of the offset may be equal to the side plate thickness. The offset allows adjacent side plates to overlap and slide between plates by means of a slot 1615 on the plate trailing end. The sections 1600 and 1605 may receive further stamping to increase the moment of inertia of the plates as shown in FIG. 5, which may allow them to carry more load without buckling. In contrast, FIG. 16 shows a plain plate without additional stamping, as may be implemented by some embodiments.

FIG. 17 is a front view of two tiers of the plate links shown in FIG. 16 with a straight down flange 1500. As shown in FIG. 17, it can be seen that the belt is locked, not being able to move inwards or outwards due to the flange 870 and straight down flange 1500 and due to bottom tab 1410.

FIG. 18 is a perspective view of an edge of a reduced radius belt. As shown in FIG. 18, the belt may include link plates having an abutment 1810with a sharp leading bend 1815 and a cut 1830 at the trailing bend 1820 of the outer abutment surface 1825 can be seen. These features allow the belt to collapse, bringing rod 1800 and rod 1805 closer together. A belt with a smaller collapsed pitch can turn lower turn ratios. In some embodiments, a cut similar to cut 1830 is also applied to the leading bend 1815. Further, a combination of leading bend and trailing bend cuts are also possible depending on the turn ratio required. In some embodiments both the sharp leading bend and trailing bend may have no cuts. Although no plate bottom tab (e.g., element 1410 shown in FIG. 17) is shown in FIG. 18, it will be understood that such a tab could be included in the embodiment shown in FIG. 18.

Standard radius belts have an approximately 60 mm pitch with intermediate rods at 30 mm at both edges. In addition, small radius belts may have a center link to act as a pivot with the outer edge on a longer pitch than the inside edge.

FIG. 19 is a perspective view of an embodiment in which the leading rod 1900 is weldless, in order to facilitate servicing, whereas the trailing rod 1905 may be welded to the plate. In some embodiments, both the trailing rod 1905 and leading rod 1900 may be weldless. In some embodiments, the rod tips may be securely held in position by fasteners 1910, which could be nuts, slotted nuts, nylon nuts, cotter pins, elastic rings or any other mechanical connection to weldlessly hold the rod to the outer abutment face 1915 of the outer abutment 1920. In some embodiments the end of rod 1900 may include a thread, groove, or a hole to receive the fastener for which it is configured to be associated. In some embodiments, fastener 1910 may be a rounded (i.e., smooth) nut.

In some embodiments, both the inner and outer edges of the belt may have fasteners to hold the leading rod. Washers, washer springs, or other suitable connection elements may be inserted between the nut and the outer abutment surface 1915 to avoid loosening of the connection. In some embodiments the fastener 1910 may be provided on every pitch, whereas in other embodiments, the fasteners may be located in just some areas of the belt for better servicing while the remainder of the belt may utilize welding to connect the rods to the abutments.

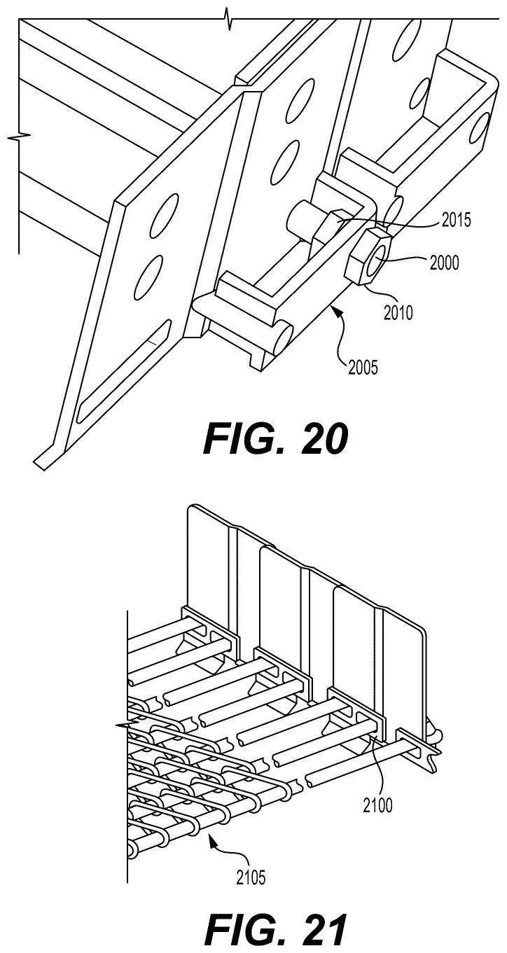

FIG. 20 is a view of another type of weldless connection between a leading rod 2000 and the outer abutment 2005 of the plate, again to facilitate servicing the belt. The connection is comprised of an outer nut 2010 and an inner nut 2015. The outer nut 2010 constrains the link so it does not move outwards and the inner nut 2015 constrain the link so it does not move inwards. The length of the threading at the rod tip may vary to accommodate the connection.

FIG. 21 is a perspective view of the stacker belt with a tension link 2100 and a wire mesh2105. Tension links are used to increase the carrying tension of the belt on wider belts. In some embodiments, tension links have 2 slots as shown in FIG. 21. Further, in some embodiments, they are straight as shown, whereas in other embodiments, they may not be straight. That is, a curved leading edge may be implemented so they better nest together during belt collapse.

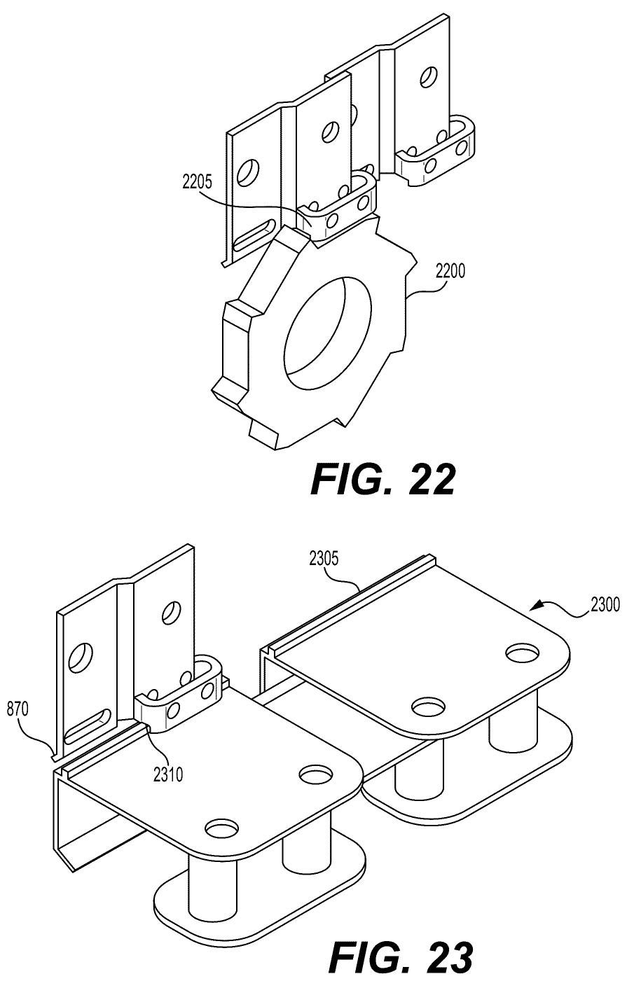

FIG. 22 is a perspective view of a spiral outfeed sprocket 2200 engaged on the self-stacking belt side plate. Sprocket teeth may engage the trailing bend 2205 in some embodiments, whereas in other embodiments, sprocket teeth may directly engage the plate transverse rods.

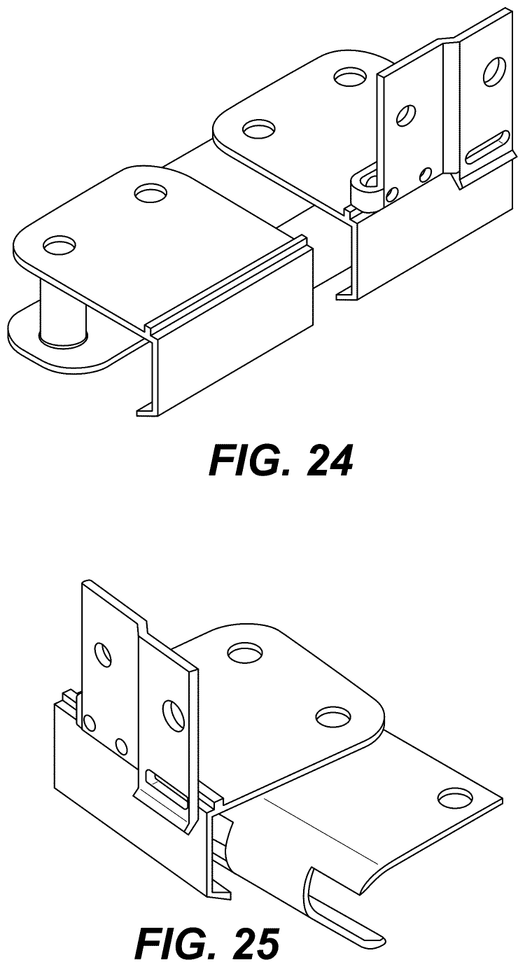

FIG. 23 is a perspective view of an embodiment of a drive chain 2300. As shown in FIG. 23, a rib 2305 directly engages the belt bottom tab 2310 so the belt cannot move inwards or outwards. The rib cross section may be square, rectangular, triangular, or any suitable shape to connect to the bottom tab 2310 of the belt plate. The rib length may be the same as the chain link or narrower than the chain link. In addition, its distance from the edge of the chain link may vary to match the self-stacking plate outer abutment size. Further, it will be noted that, for traditional belts, lateral displacement of the belt on the outer or inner chain causes de-stacking of the pile of the belt on the first tier. Prior art outer drive chains have a plain surface where the belt may slide. In contrast, the ribbed chain embodiment working in conjunction with the bottom tab 2310 of the belt link securely holds the belt in position.

In some embodiments, there is a combination of inner chains with Z tabs (as shown in FIG. 29) and ribbed outer chains. In other embodiments, both the inner chain and outer chain may be ribbed. The prior art Z tab on the inner chain holds the belt so it does not move inwards. The disclosed rib 2305 may serve the same purpose. Accordingly, adding a rib to the outer chain further constrains the belt at the first tier so it does not slide inwards on the outer chain. In some embodiments, the chain is split in 1062 mm segments with connecting links joining the segments, 14 segments are used for the inner drive chain and 17 segments are used on the outer chain but this may vary depending on the belt width and system turn ratio.

FIG. 24 is a perspective view of the inside of the ribbed chain embodiment shown in FIG. 23 connected to the self-stacking plate.

FIG. 25 is a perspective view of the main plates that compose the ribbed drive chain. Drive chains run on ball rails (not shown), and the insides of ball rails have lanes where acetal or metal balls run, whereas the outsides of the ball rails have plastic glide strips so the chain can run smoothly. Some of these features are shown in FIG. 7.

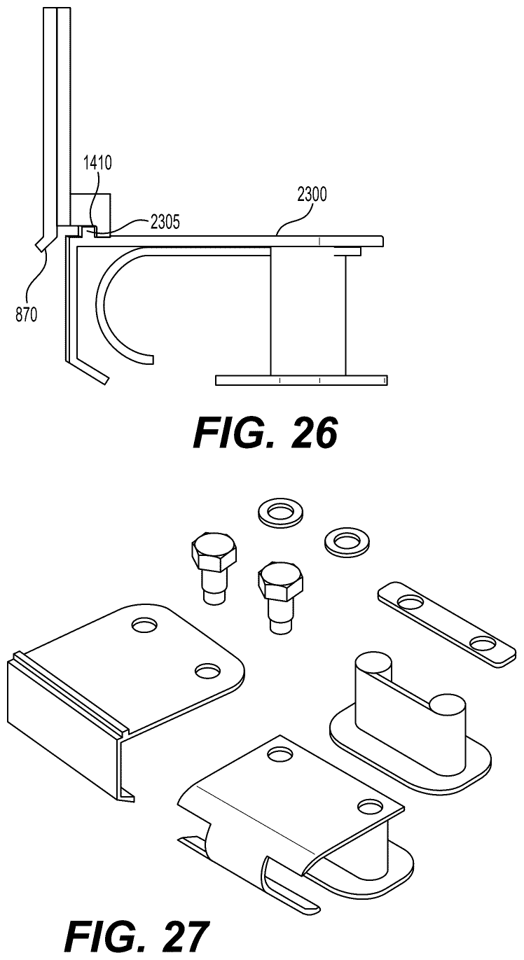

FIG. 26 is a front view of an embodiment of outer ribbed drive chain 2300 engaged on the self-stacking side plate, on this configuration belt is constrained and cannot move inwards if force is applied to the belt. Even though prior art chains have a Z tab on the inner chain to hold the belt in position, sometimes this is not enough to avoid de-stacking of the system since only friction holds the outer belt edge to the outer chain as shown in FIG. 7, when the belt is deformed due to force the belt width reduces causing slip of the belt on the outer chains.

FIG. 27 is an exploded view of the main drive chain components. The ribbed plate, inner plate, hex screws, washers, and bushes are shown in FIG. 27. The model illustrated is a pretzel chain with a plate connecting the bushes to reduce wearing against the plastic glide strips.

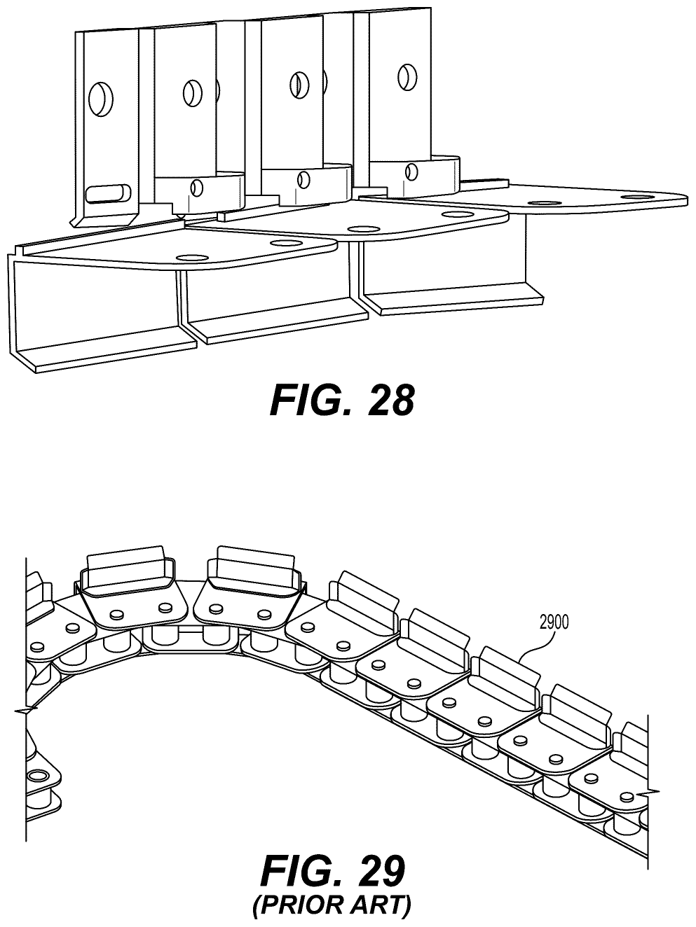

FIG. 28 is a perspective view of outer ribbed plates of the drive chain, shown on an incline of the chain. In order for the belt to engage the ribs, the chain must arrive lower than the level of the belt plates. For disengagement, the chain leaves in a downward slope and outwards to the chain sprockets so no interference between the chain ribs and belt bottom tab takes place when the chain move inwards and outwards the belt pile outer diameter. The slope on the drive chains is caused by the ball rails. Undercuts on the rails allows for correct slope of the rails and thus the chain.

FIG. 29 is a perspective view of an inner drive chain with a Z tab 2900. The prior art belt is held in a preestablished diameter by means of these tabs. In the disclosed system, chain rib 2305 holds the belt at inner diameter instead. In some embodiments, the chain rib may be placed on the outer chain as well. Both inner and outer chains are driven by sprockets which engage the bushes of the chain.

FIG. 30 is a schematic of the inner and outer drive chains that drives the pile of a self-stacking belt.

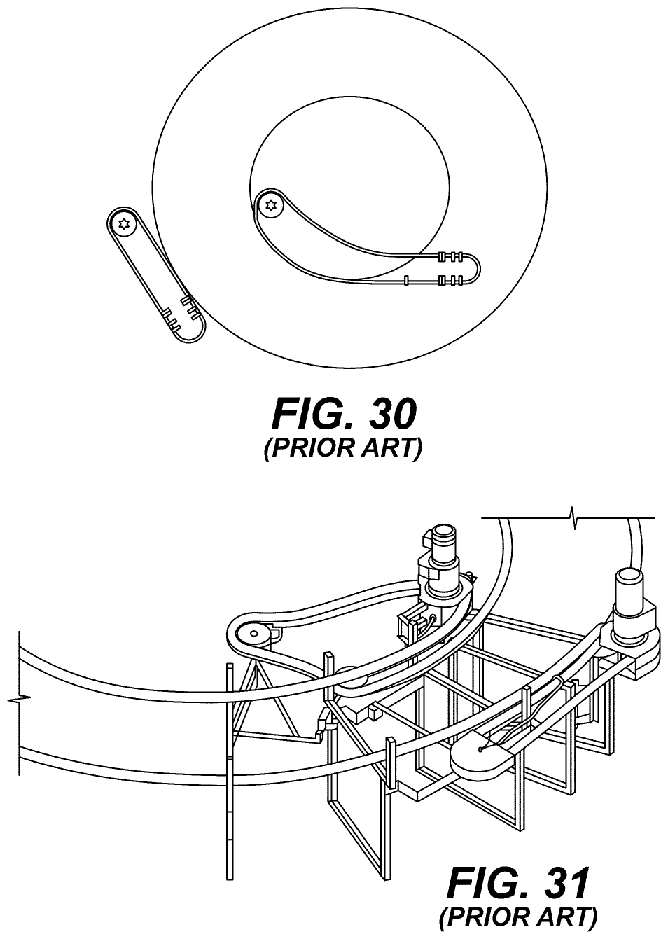

FIG. 31 is a perspective view of the inner and outer chains, drive motors and structural stands, it shows the chains work on two different levels. At the transfer point the chains must be parallel so the belt is transferred from one tier to the other on the pile.

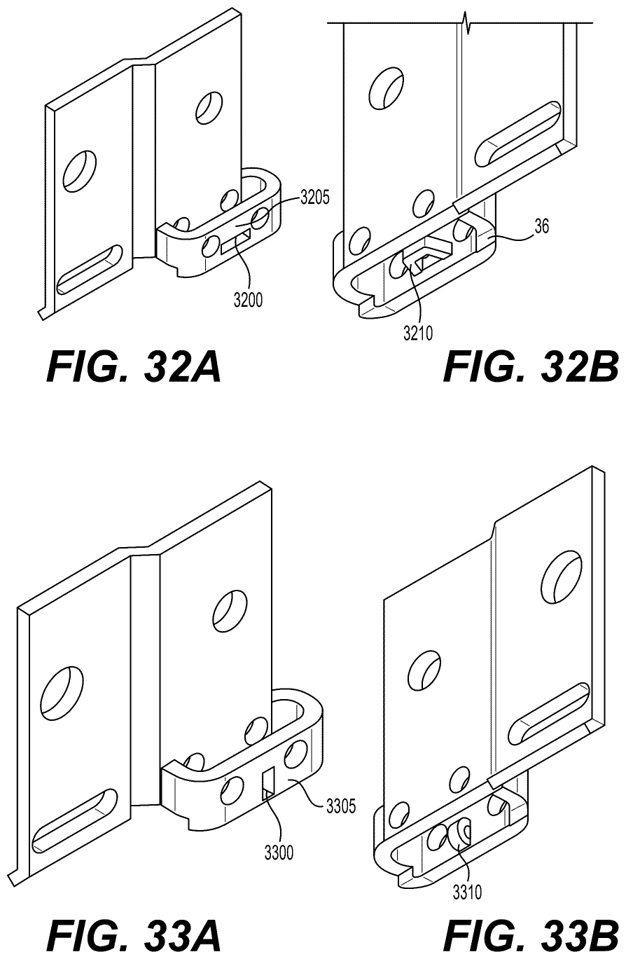

FIGS. 32A and 32B provide opposing views of a horizontal indentation 3200 on the outer abutment face 3205. The indentation 3200 creates an additional surface 3210 on the bottom of the link so contact with the upper portion of the plate of an underlying tier is improved, thus increasing the load strength and contact area.

FIGS. 33A and 33B are opposing views of a vertical indentation 3300 on the outer abutment face 3305. The vertical indentation 3300 creates a spacer 3310 to further prevent lateral movement between side plates that are on different tiers, the indentation format may vary to press the plates and correct interlock the tiers.

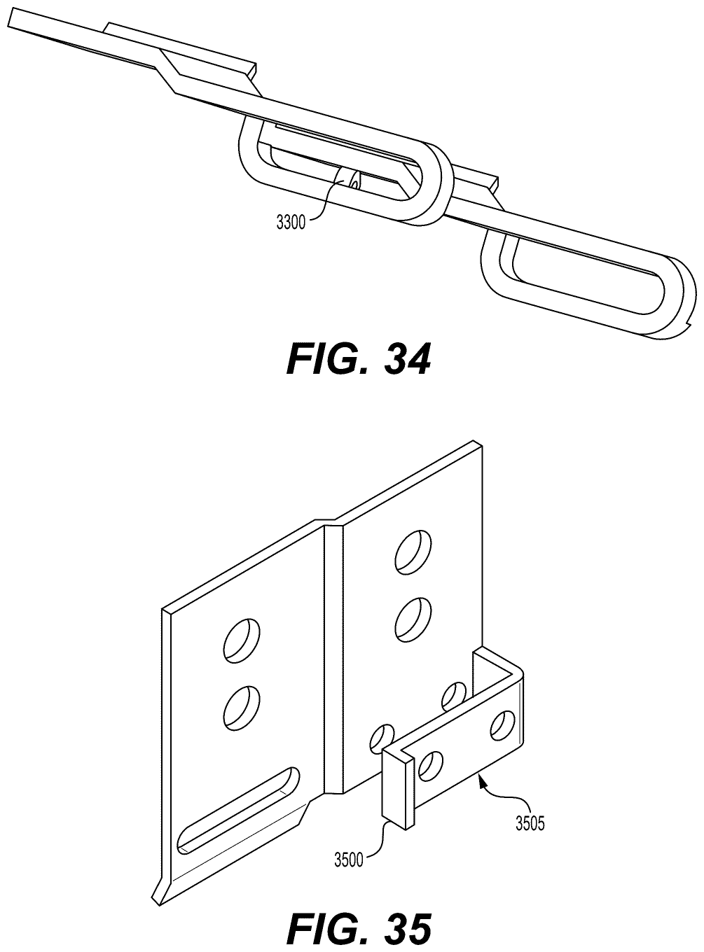

FIG. 34 is a view of two side links with a vertical indentation 3300. The links shown are interlocked. The size of the indentation 3300 may vary from 0.5-3 times the plate thickness. However, it will be appreciated that other sizes may be required. The indentation may control the tolerance of lateral movement between tiers. Further, a person of ordinary skill in the art will readily appreciate that the indentation may exhibit several other shapes.

FIG. 35 is a perspective view of a side link with a protruding tab 3500 extending from the outer abutment 3505 for side engagement so the belt is side driven. For example, some spiral systems have a rotating drum which directly engages the inside edge of the self-stacking belt for traction. In some embodiments, the self-stacking belt may be composed of alternate links with protruding tabs and no protruding tabs to create correct spacing for engagement with the central drum structure.

FIG. 36 is a perspective view of an embodiment of a heavy-duty plate link having an abutment structure 3600, which reinforces the plate to avoid buckling under high loads and for wider belts applications. The upwardly angled flange forming abutment structure 3600 may extend upward from the main abutment 3605. In some embodiments, the trailing bend 3610 and abutment structure 3600 may be welded to the plate face 3615. The format and size of the reinforcement 3600 may vary to match strength requirements for the belt.

FIG. 37 is a perspective view of an embodiment with an undercut 3700 as a resting surface on a lower edge portion of the plate element. Thus, the belt tier above of the belt pile in the spiral path is laterally aligned with the underlying tier. In some embodiments, the undercut 3700 may be square in shape, triangular or any other feasible format to ease interlock.

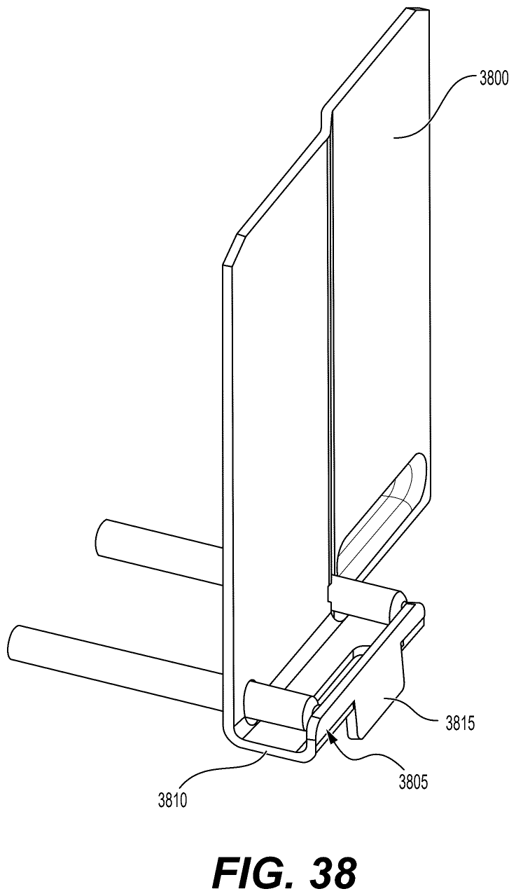

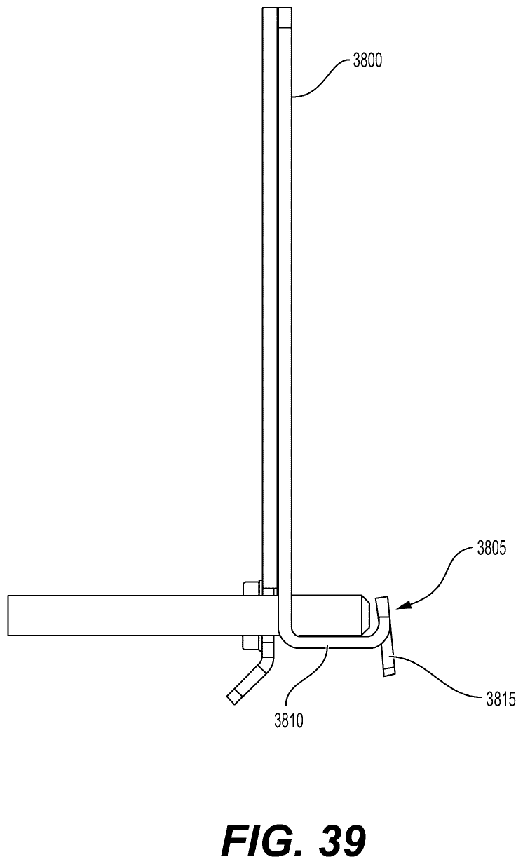

FIG. 38 is a schematic end view of an embodiment of a lateral plate element with an underside bend. As shown in FIG. 38, a lateral plate element 3800 may include an abutment 3805 including an underside bend 3810. In addition, abutment 3805 may include a downwardly extending tab 3815, which allows an underlying belt tier to rest and lock in position, similar to bottom tab 1410 shown in FIGS. 14 and 15. FIG. 39 is a schematic front view of the embodiment shown in FIG. 38.

While various embodiments have been described, the description is intended to be exemplary, rather than limiting, and it will be apparent to those of ordinary skill in the art that many more embodiments and implementations are possible that are within the scope of the embodiments. Although many possible combinations of features are shown in the accompanying figures and discussed in this detailed description, many other combinations of the disclosed features are possible. Any feature of any embodiment may be used in combination with, or substituted for, any other feature or element in any other embodiment unless specifically restricted. Therefore, it will be understood that any of the features shown and/or discussed in the present disclosure may be implemented together in any suitable combination. Accordingly, the embodiments are not to be restricted except in light of the attached claims and their equivalents. Also, various modifications and changes may be made within the scope of the attached claims.

1. A lateral plate element for a link of a self-stacking endless conveyor belt, comprising:
an outer plate section, an inner plate section and a connection bend section connecting said outer and inner plate sections;
a resting surface arranged to engage a lateral plate element of an underlying tier of the self-stacking endless conveyor belt when it extends helically;
an inner abutment, arranged to engage an upper portion of the underlying lateral plate element, wherein the inner abutment surface limits outward lateral movement of the lateral plate element relative to the underlying lateral plate element; and
an outer abutment surface arranged to engage the upper portion of the underlying lateral plate element, wherein the outer abutment surface limits inward lateral movement of the lateral plate element relative the underlying lateral plate element.

2. The lateral plate element of claim 1, wherein the outer abutment surface includes both a leading bend and trailing bend.

3. The lateral plate element of claim 2, wherein the outer abutment surface created by the leading bend is configured to cover two transverse rods.

4. The lateral plate element of claim 2, wherein the outer abutment surface created by the leading bend is configured to cover only the closest rod to the bend.

5. The lateral plate element of claim 1, wherein the inner abutment surface is formed by first flange that extends diagonally downward from a bottom portion of the lateral plate element, and a second flange extending substantially straight downward from the first flange.

6. The lateral plate element of claim 1, wherein the outer abutment surface has a bottom tab for locking an underlying plate in place.

7. The lateral plate element of claim 1, wherein the connection of a transverse rod to the outer abutment surface is made by a rounded nut.

8. The lateral plate element of claim 1, wherein the trailing bend includes a recess configured to receive a rod.

9. The lateral plate element of claim 1, wherein the outer abutment face includes a horizontal indentation.

10. The lateral plate element of claim 9, wherein the indentation forms a protrusion on an opposing side, wherein the protrusion is configured to abut an underlying plate when the belt is stacked.

11. The lateral plate element of claim 1, wherein the outer abutment face includes a vertical indentation.

12. The lateral plate element of claim 1, wherein the outer abutment includes a protruding tab configured to engage with a drive for a side-driven belt.

13. The lateral plate element of claim 1, wherein a trailing portion of the outer abutment includes a triangular notch configured to receive an underlying plate when tiers of the belt are stacked.

14. A drive chain for a conveyor belt, comprising:
a plurality of links, each link including an upper plate;
the upper plate including an upwardly projecting rib extending along a length of the link.

15. The drive chain of claim 14, wherein the drive chain is configured for use on an outer edge of a conveyor belt.

16. The drive chain of claim 14, wherein the drive chain is configured for use on an inner edge of a conveyor belt.

17. The drive chain of claim 14, wherein the rib has a square cross section, a rectangular cross section, a triangular cross section, or a circular cross section.

18. A drive system for a conveyor belt, comprising:
a set of inner and outer chains;
wherein each of the chains includes a plurality of links, each link having an upper plate;
the upper plate including an upwardly projecting rib extending along a length of the link, such that both the inner chain and the outer chain have a rib.

19. A spiral conveyor belt system, comprising:
a plurality of interconnected links and rods in which the conveyor belt extends helically along part of its length such that upper edge portions of the lateral plate elements of the links in an underlying belt tier bear against lower edge portions of the lateral plate elements of the links in an overlying belt tier, the lateral plate element of the link comprising:
an outer abutment arranged to engage the upper portion of the underlying lateral plate element, wherein the outer abutment surface limits inward lateral movement of the lateral plate element relative the underlying lateral plate element; and
a drive chain including a plurality of chain links, each chain link including an upper plate;
the upper plate including an upwardly projecting rib extending along a length of the link;
wherein the outer abutment includes a notch on an underside of the outer abutment, wherein the notch is configured to receive the upwardly projecting rib of the drive chain.

20. A lateral plate element for a link of a self-stacking endless conveyor belt, comprising:
an outer plate section, an inner plate section and a connection bend section connecting said outer and inner plate sections;
a resting surface arranged to engage a lateral plate element of an underlying tier of the self-stacking endless conveyor belt when it extends helically; and
an outer abutment including an underside bend and a downwardly extending tab configured to limit inward lateral movement of the lateral plate element relative an underlying lateral plate element.
